(19) United States
(12) Patent Application Publication
(10) Pub. No.: US 2013/0240340 A1
(43) Pub. Date: Sep. 19, 2013

(54) DOORBELL BYPASS SWITCH

(71) Applicant: Barry Wilson, SR., Aurora, IL (US)

(72) Inventor: Barry Wilson, SR., Aurora, IL (US)

(21) Appl. No.: 13/787,428

(22) Filed: Mar. 6, 2013

Related U.S. Application Data
(60) Provisional application No. 61/607,565, filed on Mar. 6, 2012.

(51) Int. Cl. H01H 23/02

(52) U.S. Cl. CPC H01H 23/02
USPC 200/553

(57) ABSTRACT

A doorbell bypass switch that includes a base switch coupled to a doorbell, the base switch is activated and deactivated to temporarily disable and reactivate the doorbell and a pair of wires coupled to the base switch, the pair of wires includes a first wire and a second wire. The doorbell bypass switch also includes a plurality of wire clips that includes a first wire clip, a second wire clip and a third wire clip and a wire nut coupled to a second end of the first wire and to a first end of a white power wire, the white power wire to provide electrical power to the doorbell bypass switch.

This application claims priority to U.S. Provisional Application 61/607,565 filed on Mar. 6, 2013, the entire disclosure of which is incorporated by reference.

### FIELD OF THE INVENTION

The present invention generally relates to a bypass switch. More specifically, the invention is a doorbell bypass switch.

### BACKGROUND OF THE INVENTION

Doorbells serve an important function to notify when a person is at a door. They can be utilized at residential and commercial properties. There are however, times when it is desirable to temporarily disable a doorbell.

### SUMMARY OF THE INVENTION

The present invention generally relates to a bypass switch. More specifically, the invention is a doorbell bypass switch.

The doorbell bypass switch includes a light emitted diode rocker base switch coupled to a top portion of a doorbell, the base switch is activated and deactivated to temporarily disable and reactivate the doorbell and a pair of wires coupled to the base switch, the pair of wires includes a first wire and a second wire. The doorbell bypass switch also includes a plurality of wire clips that includes a first wire clip, a second wire clip and a third wire clip, the first wire clip couples a first end of the first wire to an ON side of the base switch, the second wire clip couples a first end of the second wire to an OFF side of the base switch and the third wire clip couples a second end of the second wire to a front terminal of the doorbell and a wire nut coupled to a second end of the first wire and to a first end of a white power wire, the white power wire to provide electrical power to the doorbell bypass switch.

It is an object of the invention to provide a doorbell bypass switch that allows a user to temporarily disable a doorbell.

It is an object of the invention to provide a doorbell bypass switch that temporarily disables a doorbell to prevent adults, pets, infants and children from being disturbed by a sound from an activated doorbell.

It is an object of the invention to provide a doorbell bypass switch that includes a toggle switch, a lighted switch, a light emitted diode switch or LED switch, a timer switch, a remote control switch and one or more indicator LED lights mounted on a front or a side panel of a doorbell.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front perspective view of a doorbell bypass switch, in accordance with one embodiment of the present invention.

FIG. 2 illustrates an electrical diagram of a doorbell bypass switch, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention can be practiced with only some of the described aspects. For purposes of explanation, specific numbers, materials and configurations are set forth in order to provide a thorough understanding of the illustrative embodiments. However, it will be apparent to one skilled in the art that the present invention can be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it can. The terms “comprising”, “having” and “including” are synonymous, unless the context dictates otherwise.

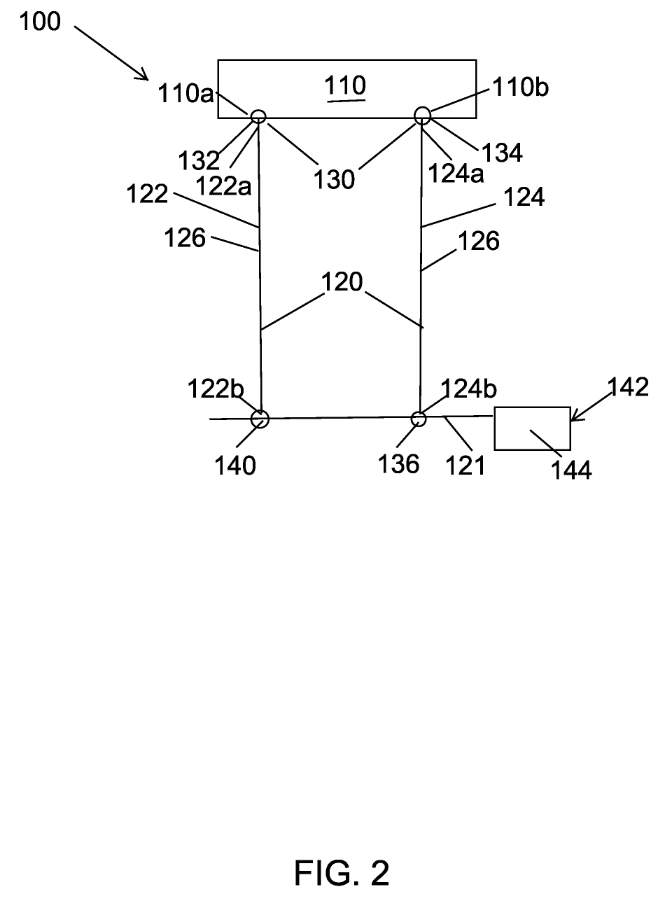

FIG. 1 illustrates a front perspective view of a doorbell bypass switch 100, in accordance with one embodiment of the present invention.

The doorbell bypass switch 100 includes a base switch 110. The base switch 110 can be a light emitted diode or LED rocker switch 112, a remote control switch 113, a timer switch (not shown), a simple rocker switch (not shown), a toggle switch (not shown), or other suitable type of switch. FIG. 1 illustrates a LED rocker switch 112. The base switch 110 can be coupled to a doorbell 114 and can be activated to temporarily disable and reactivate the doorbell 114. The remote control switch 113 can be disposed on a remote control 116 in communication with the doorbell bypass switch 100 to temporarily disable the doorbell 114 with the remote control 116 when depressed. The base switch 110 can be coupled to any suitable portion of the doorbell 114. FIG. 1 illustrates the LED rocker switch 112 coupled to a top portion 118 of the doorbell 114. The base switch 110 can be activated and deactivated to temporarily disable and reactivate the doorbell 114. The base switch 110 also includes a fastener 115 such as a nut and bolt 115a or other suitable fastener to couple the base switch 110 to the doorbell 114.

FIG. 2 illustrates an electrical diagram of a doorbell bypass switch 100, in accordance with one embodiment of the present invention.

The doorbell bypass switch 100 includes a base switch 110, a pair of wires 120, a plurality of wire clips 130 and a wire nut 140.

The pair of wires 120 includes a first wire 122 and a second wire 124. The pair of wires 120 can be coupled to the base switch 110. The pair of wires 120 can be a pair of 18 gauge wires 126 or any other suitable gauge of wire. The wire clips 130 can include a first wire clip 132, a second wire clip 134 and a third wire clip 136. The first wire clip 132 couples a first end 122a of the first wire 122 to an ON side 110a of the base switch 110. The second wire clip 134 couples a first end 124a of the second wire 124 to an OFF side 110b of the base switch 110. The third wire clip 136 couples a second end 124b of the second wire 124 to a front terminal 114a of the doorbell 114. The wire nut 140 couples a second end 122b of the first wire 122 to a first end 121a of a white power wire 121 typically disconnected from a power source 142 such as a power transformer 144 or other suitable power source to provide electrical power to the doorbell bypass switch 100.

While the present invention has been related in terms of the foregoing embodiments, those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A doorbell bypass switch, comprising:
a base switch coupled to a doorbell, the base switch is activated and deactivated to temporarily disable and reactivate the doorbell;
a pair of wires coupled to the base switch, the pair of wires includes a first wire and a second wire;
a plurality of wire clips that includes a first wire clip, a second wire clip and a third wire clip, the first wire clip couples a first end of the first wire to an ON side of the base switch, the second wire clip couples a first end of the second wire to an OFF side of the base switch and the third wire clip couples a second end of the second wire to a front terminal of the doorbell; and
a wire nut coupled to a second end of the first wire and to a first end of a white power wire, the white power wire to provide electrical power to the doorbell bypass switch.

2. The doorbell bypass switch according to claim 1, wherein the base switch is a light emitted diode rocker switch.

3. The doorbell bypass switch according to claim 1, wherein the base switch is coupled to a top portion of the doorbell.

4. The doorbell bypass switch according to claim 1, wherein the base switch includes a fastener to couple the base switch to the doorbell.

5. The doorbell bypass switch according to claim 1, further comprising a remote control in communication with the doorbell bypass switch.

6. The doorbell bypass switch according to claim 5, wherein the remote control includes a remote control switch, the remote control switch temporarily disables the doorbell when depressed.

7. A doorbell bypass switch, comprising:
a light emitted diode rocker base switch coupled to a doorbell, the base switch is activated and deactivated to temporarily disable and reactivate the doorbell;
a pair of wires coupled to the base switch, the pair of wires includes a first wire and a second wire;
a plurality of wire clips that includes a first wire clip, a second wire clip and a third wire clip, the first wire clip couples a first end of the first wire to an ON side of the base switch, the second wire clip couples a first end of the second wire to an OFF side of the base switch and the third wire clip couples a second end of the second wire to a front terminal of the doorbell; and
a wire nut coupled to a second end of the first wire and to a first end of a white power wire, the white power wire to provide electrical power to the doorbell bypass switch.

8. The doorbell bypass switch according to claim 7, wherein the base switch includes a fastener to couple the base switch to the doorbell.

9. The doorbell bypass switch according to claim 8, wherein the fastener is a nut and bolt.

10. The doorbell bypass switch according to claim 7, wherein the pair of wires is a pair of 18 gauge wires.

11. The doorbell bypass switch according to claim 7, further comprising a remote control in communication with the doorbell bypass switch.

12. The doorbell bypass switch according to claim 11, wherein the remote control includes a remote control switch, the remote control switch temporarily disables the doorbell when depressed.

13. A doorbell bypass switch, comprising:
a light emitted diode rocker base switch coupled to a top portion of a doorbell, the base switch is activated and deactivated to temporarily disable and reactivate the doorbell;
a pair of wires coupled to the base switch, the pair of wires includes a first wire and a second wire;
a plurality of wire clips that includes a first wire clip, a second wire clip and a third wire clip, the first wire clip couples a first end of the first wire to an ON side of the base switch, the second wire clip couples a first end of the second wire to an OFF side of the base switch and the third wire clip couples a second end of the second wire to a front terminal of the doorbell; and
a wire nut coupled to a second end of the first wire and to a first end of a white power wire, the white power wire to provide electrical power to the doorbell bypass switch.

14. The doorbell bypass switch according to claim 13, wherein the base switch includes a fastener to couple the base switch to the doorbell.

15. The doorbell bypass switch according to claim 14, wherein the fastener is a nut and bolt.

16. The doorbell bypass switch according to claim 13, wherein the pair of wires is a pair of 18 gauge wires.

17. The doorbell bypass switch according to claim 13, wherein the wire nut couples the second end of the first wire to the first end of the white power wire disconnected from an electrical power source to provide electrical power to the doorbell bypass switch.

18. The doorbell bypass switch according to claim 17, wherein the power source is a transformer.

19. The doorbell bypass switch according to claim 13, further comprising a remote control in communication with the doorbell bypass switch.

20. The doorbell bypass switch according to claim 19, wherein the remote control includes a remote control switch, the remote control switch temporarily disables the doorbell when depressed.
